(19) United States
(12) Patent Application Publication
(10) Pub. No.: US 2019/0034259 A1
(43) Pub. Date: Jan. 31, 2019

(54) Systems and Methods for Implementing a Thread Trace Log

(71) Applicant: KYOCERA Document Solutions Inc., Osaka (JP)

(72) Inventor: Zhenhai Jiang, Torrance, CA (US)

(21) Appl. No.: 15/659,284

(22) Filed: Jul. 25, 2017

(51) Int. Cl. G06F 11/07; G06F 11/22

(52) U.S. Cl. CPC G06F 11/0715; G06F 21/50; G06F 11/0787; G06F 11/2205

(57) ABSTRACT

Example systems and related methods may relate to error detection in multi-threaded systems. Namely, a computing device includes a processor and a memory. The computing device also includes program instructions, stored in the memory, that upon execution by the processor cause the computing device to perform operations. The operations include receiving, by the processor, a communication signal. The communication signal initiates a first thread of at least two threads. The operations include sending, by the first thread via the processor, an inter-thread communication message to a second thread of the at least two threads. The operations include storing, in a trace log in the memory, information related to a state of the first thread and the inter-thread communication message. The operations include identifying an error location based on the information stored in the trace log.

### BACKGROUND

Printing devices have become more complex in design and implementation. In most cases, printers are implemented as multi-threaded systems. Printing devices may employ multi-threaded approaches in processing and printing images. For example, a printing device may partition an image into bands. The printing device may allocate the processing of different tasks related to each band to at least two threads of a multi-threaded system. This way, the printing device can process different tasks for each band in parallel, which allows the printing device to process and print an image faster.

However, error detection in a multi-threaded system can be cumbersome and inefficient in many circumstances. Thus, a need exists for an efficient system and method for detecting errors in multi-threaded printing systems.

### SUMMARY

In a first aspect, a method is provided. The method includes receiving, by the processor, a communication signal. The communication signal initiates a first thread of at least two threads. The execution by the processor of the program instructions configures the first thread of the at least two threads to perform tasks related to a first element of the multi-threaded printing system. The first element may relate to a particular objective of the multi-threaded printing system, while the first thread may relate to the part of the multi-threaded system that is carrying out the first element. The method includes sending, by the first thread via the processor, an inter-thread communication message to a second thread of the at least two threads, wherein execution by the processor of the program instructions configures the second thread of the at least two threads to perform tasks related to a second element of the multi-threaded printing system. The method includes storing, in a Thread Trace Log in the memory, information related to the state of the first thread and the inter-thread communication message. The method includes identifying, by the computing device, an error location based on the information stored in the Thread Trace Log.

In a second aspect, a computing device is provided. The computing device includes a processor and a memory. The computing device also includes program instructions, stored in the memory, that upon execution by the processor cause the computing device to perform operations. The operations include receiving, by the processor, a communication signal. The communication signal initiates a first thread of at least two threads. The execution by the processor of the program instructions configures the first thread of the at least two threads to perform tasks related to a first element of the multi-threaded printing system. The operations include sending, by the first thread via the processor, an inter-thread communication message to a second thread of the at least two threads, wherein execution by the processor of the program instructions configures the second thread of the at least two threads to perform tasks related to a second element of the multi-threaded printing system. The operations include storing, in a Thread Trace Log in the memory, information related to the state of the first thread and the inter-thread communication message. The operations include identifying an error location based on the information stored in the Thread Trace Log.

In a third aspect, a tangible, non-transitory computer-readable medium is provided. The tangible, non-transitory computer-readable medium includes program instructions encoded therein. The program instructions, when executed by one or more processors, cause a printing device to perform a method. The method includes receiving, by the processor, a communication signal. The communication signal initiates a first thread of at least two threads. The execution by the processor of the program instructions configures the first thread of the at least two threads to perform tasks related to a first element of the multi-threaded printing system. The method includes sending, by the first thread via the processor, an inter-thread communication message to a second thread of the at least two threads, wherein execution by the processor of the program instructions configures the second thread of the at least two threads to perform tasks related to a second element of the multi-threaded printing system. The method includes storing, in a Thread Trace Log in the memory, information related to the state of the first thread and the inter-thread communication message. The method includes identifying, by the computing device, an error location based on the information stored in the Thread Trace Log.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a schematic block diagram illustrating a multi-threaded system, according to an example embodiment;

FIG. 2 is a schematic block diagram illustrating a multi-threaded system, according to an example embodiment;

FIG. 3 is a schematic block diagram illustrating a multi-threaded system, according to an example embodiment;

FIG. 4 is a schematic block diagram illustrating a multi-threaded system, according to an example embodiment; and

FIG. 5 is a flow diagram illustrating a method, according to an example embodiment.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Many devices may implement a multi-threaded embedded system to perform tasks quickly and efficiently. For example, a printing device may use a multi-threaded architecture to process and print images faster than if the printing device had not used a multi-threaded architecture. In this example, the printing device may divide the image into bands during the printing process. Bands may include small portions of the overall image to be printed. The printing device may perform one or more sets of tasks related to the band of the printer image.

Occasionally, an error may occur while the printer is attempting to print an image using a multi-threaded architecture. When this error occurs, it may be difficult for a technician or engineer to identify the error due to the complexity of the multi-threaded system. It may be even more difficult to identify the error when the error is a system hang. This is because when a system hangs, the system may appear idle.

Previously, a technician or engineer may attempt to debug the code, typically by compiling and executing the code with breakpoints. These breakpoints may stop the program at various locations, allowing the engineer to step-through the code. Stepping through the code may involve executing the code line by line and observing the outcome. This debugging method changes the system timing in multi-threaded embedded systems and may cause an error not to appear. Another issue with using breakpoints is that the debugging cannot be performed remotely, thus an engineer cannot debug a problem that occurs at the customer's location.

Systems and methods are disclosed herein that provide more accurate and efficient error detection in multi-threaded systems. It should be recognized that the multi-threaded system can allocate a number of different tasks to at least two threads. During allocation and execution of these tasks, an error may occur. The described method and system may be applied to such situations.

As an example, a multi-threaded printing system may receive a transmission to print a particular image or document. The printing system may have a computing device with a processor and a memory. The printing system may also have other components. The printing system may divide the image into multiple bands for printing. The printing system, via program instructions, may assign different tasks relating to different bands to at least two threads of the multi-threaded printing system. The at least two threads may then perform the particular tasks assigned to it. While the at least two threads are performing their respective tasks, the threads may send data to a Thread Trace Log stored in the memory of the printing system. The data sent to the Thread Trace Log may include information pertaining to the band ID, message queue ID and particular task the thread was assigned. This trace information can enable a technician or engineer to quickly locate the error.

In an example embodiment, an error may occur while the at least two threads are performing their respective tasks. As a result, one or more tasks may not be completed. In response to determining an error has occurred during printing, the printing system may identify the error location by analyzing the information stored in the Thread Trace Log. The printing system may identify the error location by comparing the Thread Trace Log with expected behavior. A technician or engineer may also identify the error location. The expected behavior may be an expected or correct Thread Trace Log entry. After identifying the error location, the printing system may provide an indication of the error location, providing the ability for a technician or engineer to fix the defective programming code.

The methods described herein may involve using inter-thread communication mechanisms (e.g., message queues, semaphores, mutexes, etc) to facilitate debugging of a multi-threaded system. Thread Trace Log may be wrapped around these inter-thread communication mechanisms such that when one of these inter-thread communication mechanisms is used, thread information is stored in the Thread Trace Log. These methods may allow a technician or engineer to analyze the Thread Trace Log and quickly identify which thread is encountering an error.

### II. System Examples

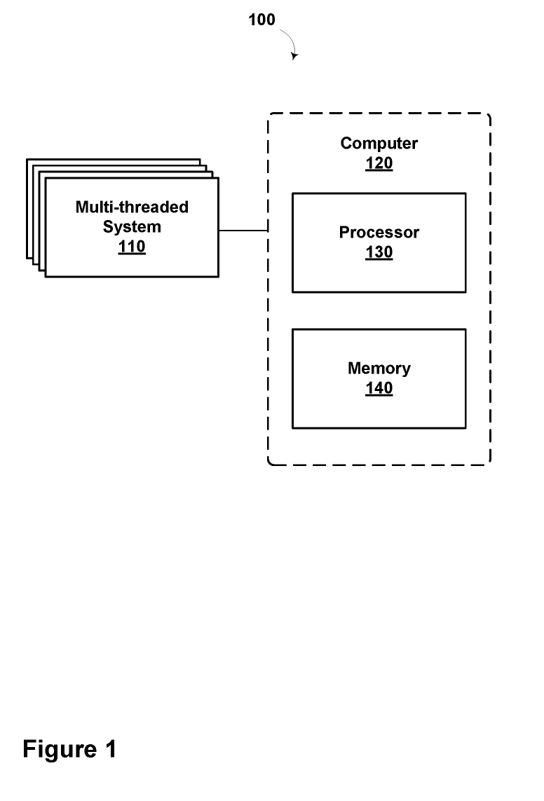

FIG. 1 is a schematic block diagram illustrating a system 100, according to an example embodiment. System 100 includes a multi-threaded system 110. Multi-threaded system 110 may include a printing system, payment software system, or communication system, for example. In a printing system, applications of multi-threaded system 110 may include debugging band data flow during image processing or debugging an erroneous print job. In a payment software system, an application of multi-threaded system 110 may include debugging the flow of payments to particular accounts. In a communication system, an application of multi-threaded system 110 may include debugging an internet protocol (“IP”) data packet. Other multi-threaded systems and applications of multi-threaded systems are also contemplated herein. Multi-threaded system 110 may include a computer 120. Computer 120 may include any type of computing device configured to receive and process a print job. Computer 120 may have a processor 130 and a memory 140. For example, the computer 120 may receive a request to print an image or document and then send the instructions to print the image or document to a processor 130, which uses a memory 140 to store program instructions. The processor 130 may be programmed to implement the program instructions with at least two threads.

The memory 140 may be associated with an allocation of physical memory. Alternatively or additionally, the memory 140 may be associated with a virtual and/or dynamic memory allocation.

In an example embodiment, the multi-threaded system 110 may receive, by its computer 120, a print job. The print job may include a document or an image. The multi-threaded system 110 may then, by its computer 120 and processor 130 via program instructions, divide the print job into bands and store them in the memory 140. The processor 130 may then assign a set of tasks associated with one or more of the bands to at least two threads of the processor 130. The at least two threads may perform the set of tasks associated with the respective band. While the at least two threads are performing their respective tasks, the at least two threads may be configured to transmit information to a Thread Trace Log stored in the memory 140. The Thread Trace Log may help facilitate error detection when the processor 130 is executing program instructions to control the computer 120 of the multi-threaded system 110.

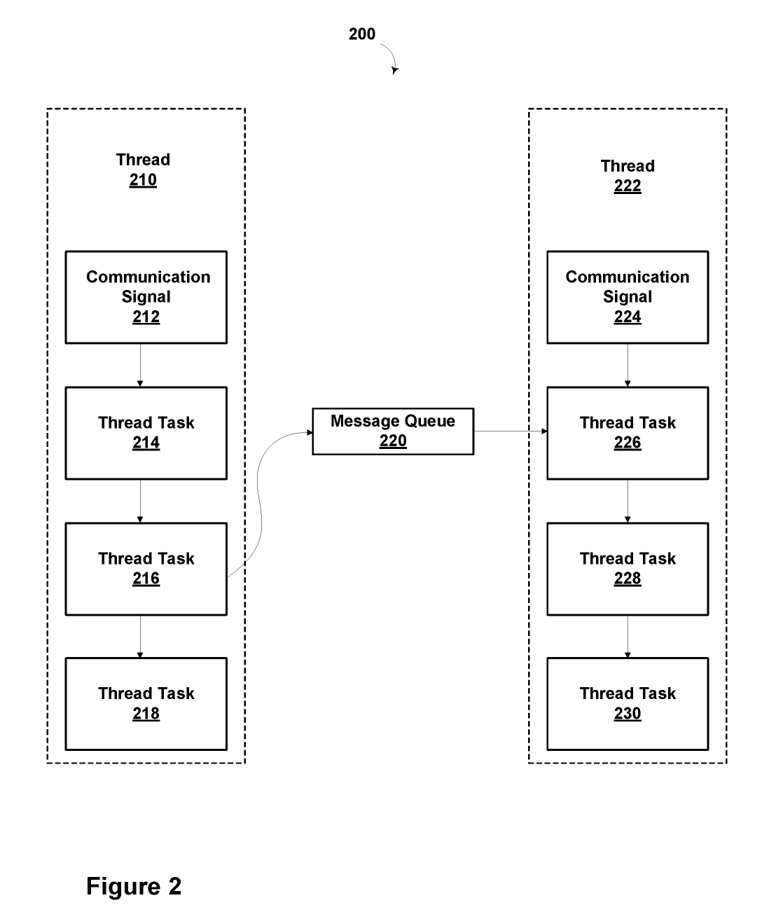

FIG. 2 is a schematic block diagram illustrating how threads communicate to one another in a multi-threaded system 200, according to an example embodiment. System 200 may represent a multi-threaded architecture connecting the processor 130 and memory 140, and system 200 may be configured to carry out functions for multi-threaded system 110. System 200 may include threads 210 and 222, and a message queue 220. While only two threads are depicted in FIG. 2, system 200 may utilize more than two threads depending on the capability of the processor and complexity of the program instructions. Thread 210 may include communication signal 212 and thread tasks 214, 216, 218. Thread 222 may include communication signal 224, and thread tasks 226, 228, and 230.

Communication signals 212 and 224 may include a semaphore or a mutex. Other communication signals may also be used. Thread tasks 214, 216, 218, 226, 228, and 230 may include any task configured to complete the overall function of threads 210 and 222. Some examples of thread tasks 214, 216, 218, 226, 228, and 230 may include executing a function, sending an inter-thread communication message, retrieving an inter-thread communication message, or sending a subsequent communication signal to another thread. Other thread task examples may be used.

Message queue 220 may be configured to handle inter-thread communication methods. Message queue 220 may include a standard message queue or a double-linked queue. Message queue 220 may assist in a multi-threaded architecture by providing the ability for threads to communicate with one another. An example of this may include thread 210 sending data regarding its processing of a first task to thread 222. Thread 222 may then adjust its run-time processes based on the data received from thread 210.

In operation, system 200 of processor 130 may receive a print job. The system 200 may then allocate the print job to threads 210 and 222. Thread 210 may then receive the communication signal 212, which may be a semaphore configured to wake up thread 210 and cause thread 210 to start processing its allocated tasks. Thread 210 may then perform thread tasks 214, 216 and 218. In this example, thread task 214 may include executing a function, such as process a portion of the print job. Thread task 216 may include sending an inter-thread communication message to the message queue 220, and thread task 218 may include sending communication signal 224 to thread 222.

Thread 222 may receive communication signal 224 from thread 210. Communication signal 224 may be a semaphore configured to wake up thread 222 to perform its allocated tasks. Thread 222 may then perform thread tasks 226, 228, and 230. Thread task 226 may include receiving the inter-thread communication message from message queue 220. Thread task 228 may include executing a function, such as processing a portion of the print job, and thread task 230 may include sending an additional communication signal to another thread of the system. Any number of combinations of thread tasks is possible.

In this example, a printing error may occur. The printing error may include a system hang, which may be caused by a deadlock on the communication signals 212 or 224. In this situation, it might not appear that an error has occurred, because the system may appear to be in an idle state. Traditional debugging methods may include setting breakpoints or stepping-through certain portions of code and observing behavior. One problem with these methods is that system timing may change during debugging and the original problem may disappear. Also, multi-threaded systems perform operations in parallel, making it difficult for an engineer to pinpoint the correct location of an error. In an example embodiment, the multi-threaded system 110 may use a trace log to help combat the problem of error location identification.

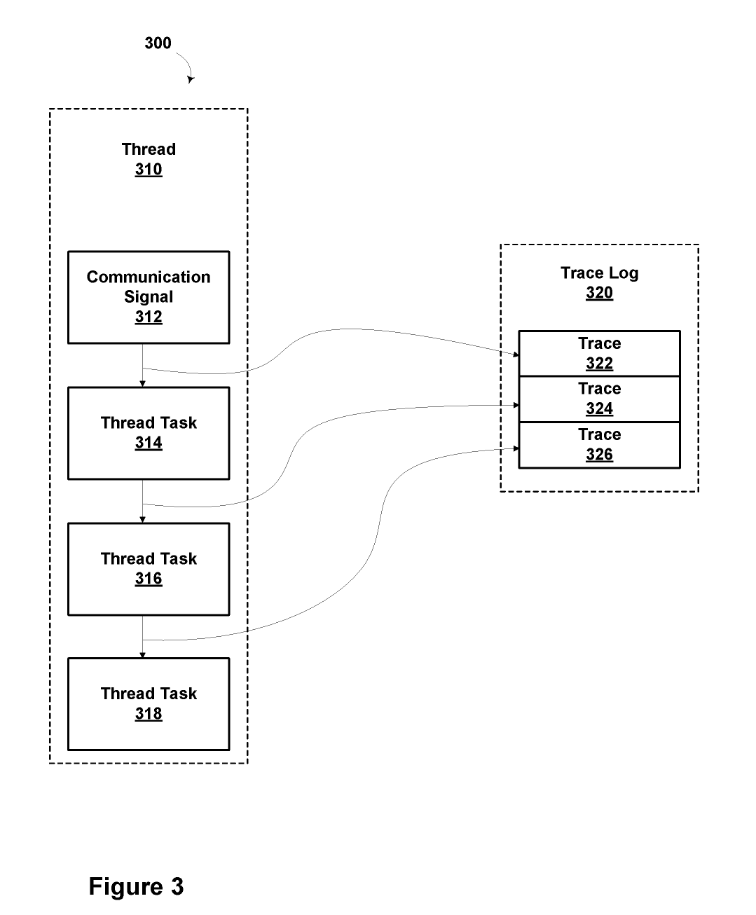

FIG. 3 is a schematic block diagram illustrating how trace log works in a multi-threaded system 300, according to an example embodiment. FIG. 3 illustrates a common use of a trace log. It logs information relating to actions inside a thread. The trace log writes a small amount of data into memory, usually several bytes at each location. The total memory allocation may be as small as several kilo-bytes. The overhead and system timing impact on system 300 may be very small. Using a trace log is efficient and effective in debugging an embedded system. Trace log can also be designed to wrap around in memory so that current trace information is available without impacting system memory space. Writing data to trace log is protected by a semaphore, making it multi-thread safe. This prevents trace data from being overwritten by another thread. Trace log data can also be outputted to a file to be examined by a remote engineer at a later time. Further, a trace log triggering mechanism can be coupled to a software error handling system, allowing trace log to automatically dump its data when an error occurs. This may be particularly useful for problems that cannot be reproduced easily.

System 300 may represent part of a multi-threaded architecture implementing a trace log mechanism. System 300 may connect the processor 130 and memory 140, and system 300 may be configured to carry out functions for multi-threaded system 110. System 300 may include a thread 310. Thread 310 may include a communication signal 312 and thread tasks 314, 316, and 318. System 300 may also include a trace log 320 with traces 322, 324, and 326.

Thread 310 may be configured, via program instructions, to execute a portion of the multi-threaded system 110. Communication signal 312 may include a semaphore or a mutex. Other communication signals may also be used. Thread tasks 314, 316, and 318 may include any task configured to complete the overall function of thread 310. Some examples of thread tasks 314, 316, and 318 may include executing a function, sending an inter-thread communication message, receiving an inter-thread communication message, or sending a subsequent communication signal to another thread. Other thread task examples may be used.

Trace log 320 may be stored in the memory 140 of the multi-threaded system 110. Trace log 320 may be configured to receive traces 322, 324, and 326. Traces 322, 324, and 326 may be sent by thread 310 after completion of various tasks. Traces 322, 324, and 326 may be implemented via program instructions on the processor 130. The program instructions may include a function call configured to send information relating to the thread to the trace log 320. The parameters of the function call may include a particular state of the thread or information relating to the performance of one of the thread tasks 314, 316, or 318. Some advantages of using a trace log include the ability to trace data flow, small overhead, and the ease in turning the tracing on and off via programming macros. Traces 322, 324, and 326 may provide an engineer with information relating to the performance of thread 310, which in turn may provide the ability to quickly and efficiently locate an error within a thread.

For example, thread 310 may receive a communication signal 312. Communication signal 312 may include a semaphore configured to initiate thread 310 to perform its allocated tasks. After receiving communication signal 312, thread 310 may send trace 322 to the trace log 320 to indicate that it has received communication signal 312 and begun working on its tasks. Trace log 320 may receive trace 322 and store it in a particular section of memory. Thread 310 may then perform thread task 314. Thread task 314 may include executing a particular function related to processing a print job. After or concurrent with performing thread task 314, thread 310 may send trace 324 to the trace log 320. Trace 324 may include information related to a particular state of thread 310 or information related to the performance of thread task 314. Thread 310 may then perform thread task 316. Thread task 316 may include sending an inter-thread communication message to another thread in the multi-threaded system 110. After or concurrent with performing thread task 316, thread 310 may send trace 326 to the trace log 320. Trace 326 may include information related to a particular state of thread 310 or information related to the performance of thread task 316. Finally, thread 310 may perform thread task 318. Thread task 318 may include sending a communication signal to another thread of the multi-threaded system 110. Any number of combinations of thread tasks is possible.

In this embodiment, trace information may be sent after each thread task or operation. In other embodiments, it may be advantageous to trace information relating to specific thread tasks. This may be advantageous over tracing all steps in a given thread because targeting specific thread tasks may speed up efficiency in locating an error when one occurs.

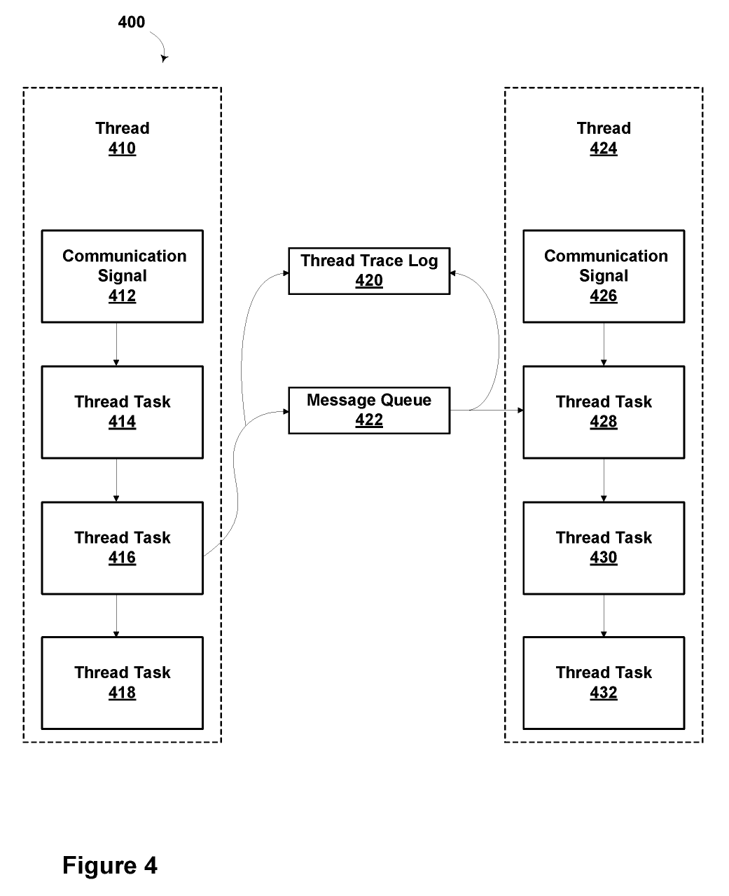

FIG. 4 is a schematic block diagram illustrating how Thread Trace Log operates in a multi-threaded system 400, according to an example embodiment. The common trace log described in FIG. 3 is a useful debug technique, but it has some limitations. The common trace log requires in-depth knowledge of which thread to log or where in the application code to add a trace point. Debugging using a common trace log may require multiple tries to detect error location. A common trace log also requires modification to application code.

Thread Trace Log takes advantage of the light-weight architecture of a common trace log and explores low-level inter-thread communication methods to assist multi-thread debugging. Thread Trace Log is more efficient than a common trace log and checks data flow at thread level. Trace information related to a thread is stored when inter-thread communication methods are used. This allows the multi-threaded system itself, or an engineer to quickly identify the thread in which the error occurred. Instrumentation for the Thread Trace Log is inside low level inter-thread communication methods. Typically, the application code doesn't need to be changed to implement the Thread Trace Log.

System 400 may represent a multi-threaded architecture implementing a trace log mechanism tied to an inter-thread communication method. System 400 may connect the processor 130 and memory 140, and system 300 may be configured to carry out functions for multi-threaded system 110. System 400 may include threads 410 and 424. Thread 410 may include a communication signal 412 and thread tasks 414, 416, and 418. Thread 424 may include a communication signal 426 and thread tasks 428, 430, and 432. System 400 may also include a Thread Trace Log 420 and a message queue 422.

Threads 410 and 424 may be configured, via program instructions, to execute a portion of the multi-threaded system 110. Communication signals 412 and 426 may include a semaphore or a mutex. Other communication signals may also be used. Thread tasks 414, 416, 418, 428, 430, and 432 may include any task configured to complete the overall function of threads 410 and 424. Some examples of thread tasks 414, 416, 418, 428, 430, and 432 may include executing a function, sending an inter-thread communication message, retrieving an inter-thread communication message, or sending a subsequent communication signal to another thread. Other thread task examples may be used.

Message queue 422 may be configured to handle inter-thread communication methods. Message queue 422 may include a standard message queue or a double-linked queue. Message queue 422 may assist in a multi-threaded architecture by providing the ability for threads to communicate with one another. An example of this may include thread 410 sending data regarding its processing of a first task to thread 424. Thread 424 may then adjust its run-time processes based on the data received from thread 410.

Thread Trace Log 420 may be stored in the memory 140 of the multi-threaded system 110. Thread Trace Log 420 may be implemented to track operations in message queue 422. Storing the information may include executing a function with a parameter. The parameter may include a particular state of threads 410 and 424 or information related to thread tasks 416 and 428. In this example, Thread Trace Log 420 may store trace information from message queue 422, which connects thread 410 and thread 424. In practice, any thread in this multi-thread system can store trace information into Thread Trace Log 420. Storing trace information from message queue 422 makes identifying an error location or the point of a system hang more reliable and accurate.

In operation, system 400 of processor 130 may receive a print job. The system 400 may then allocate the print job to threads 410 and 424. Thread 410 may then receive the communication signal 412, which may be a semaphore configured to wake up thread 410 and cause thread 410 to start processing its allocated tasks. The semaphore may be sent from another thread (not shown here). Thread 410 may then perform thread tasks 414, 416 and 418. In this example, thread task 414 may include executing a function, such as processing a portion of the print job. Thread task 416 may include sending an inter-thread communication message to the message queue 422. After or concurrent with sending the inter-thread communication message to the message queue 422, thread 410 may send trace information to the Thread Trace Log 420. The trace information may include the particular state of thread 410 or information relating to the performance of thread task 416. Thread task 418 may include sending communication signal 426 to thread 424. Any number of combinations of thread tasks is possible. Once thread 410 finishes thread tasks 414, 416, and 418, thread 410 may loop back to wait on a subsequent communication signal 412.

Thread 424 may receive communication signal 426 from thread 410. Communication signal 426 may be a semaphore configured to wake up thread 424 to perform its allocated tasks. Thread 424 may then perform thread tasks 428, 430, and 432. Thread task 428 may include receiving the inter-thread communication message from message queue 422. After or concurrent with receiving the inter-thread communication message from message queue 422, thread 424 may send trace information to Thread Trace Log 420. The trace information may include the particular state of thread 424 or information relating to the performance of thread task 428. Thread task 430 may include executing a function, such as processing a portion of the print job, and thread task 432 may include sending an additional communication signal to another thread of the system. Any number of combinations of thread tasks is possible. Once thread 424 is finished completing thread tasks 428, 430, and 432, thread 424 may loop back to wait for a subsequent communication signal 426.

In this embodiment, the trace information in Thread Trace Log 420 is tied to the message queue 422. This is advantageous because every time an inter-thread communication message is sent or received, data is stored in the Thread Trace Log. This assists in combatting debugging issues during system hangs and semaphore deadlocks. For example, if an error occurs in thread 424, such as failure to activate thread 424 via communication signal 426, then thread task 428 will not be performed and no data will be written to Thread Trace Log 420. After an error is suspected, the system 400 may compare the information stored in Thread Trace Log 420 to an expected outcome for a correct Thread Trace Log 420. After comparing the information stored in Thread Trace Log 420 to the expected outcome, the system 400 may identify the location of the error. The system 400 may identify the error location by sending Trace Log 420 to a human technician for comparison with expected behavior of Trace Log 420. System 400 may then receive an error input from the human technician, wherein the error input is a difference between Trace Log 420 and the expected behavior of Trace Log 420.

### III. Method Examples

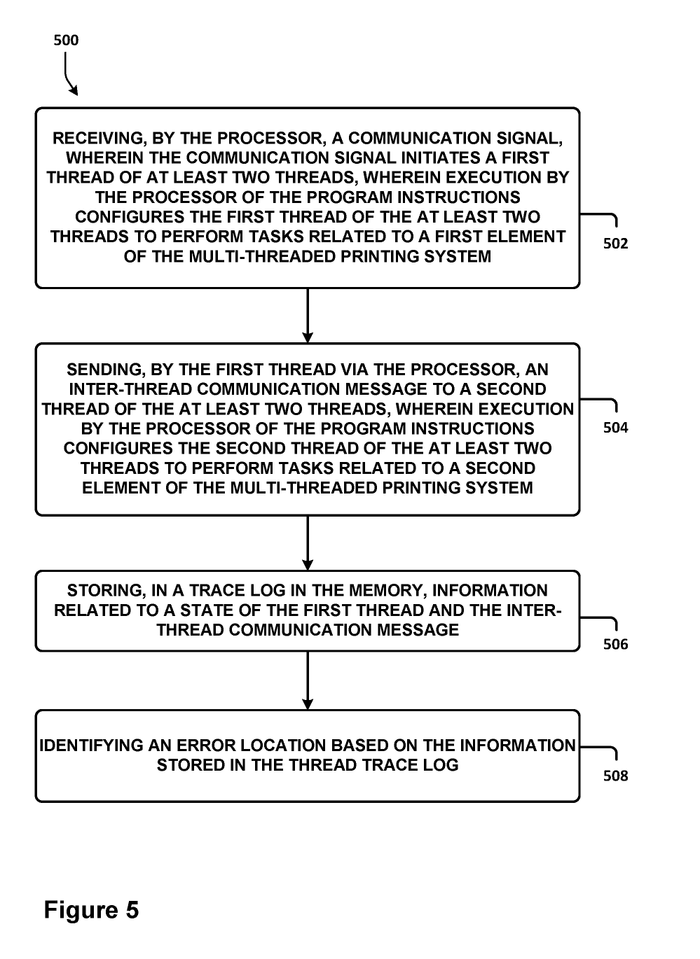

FIG. 5 illustrates a method, according to an example embodiment. The method includes blocks that may be carried out in an order other than that illustrated. Furthermore, various blocks may be added to or subtracted from the described methods within the intended scope of this disclosure. The methods may correspond to steps that may be carried out using some or all of the elements of system 200, system 300, and/or system 400, as illustrated and described in reference to FIGS. 2-4.

FIG. 5 is a flow diagram illustrating a method 500, according to an example embodiment. Method 500 describes how Thread Trace Log operates. Block 502 may include receiving, by a processor, a communication signal. The communication signal may include a semaphore or a mutex. The communication signal may initiate a first thread of at least two threads, wherein execution by the processor of program instructions configures the first thread of the at least two threads to perform tasks related to a first element of the multi-threaded printing system. The first element of the multi-threaded printing system may include performing one set of tasks related to a band of a printer image.

Block 504 may include sending, by the first thread via the processor, an inter-thread communication message to a second thread of the at least two threads, wherein execution by the processor of the program instructions configures the second thread of the at least two threads to perform tasks related to a second element of the multi-threaded printing system. The second element of the multi-threaded printing system may include performing another set of tasks related to the band of the printer image. Alternatively or additionally, sending the inter-thread communication message may include sending the inter-thread communication message via a message queue.

Block 506 may include storing, in a Thread Trace Log in the memory, information related to a state of the first thread and the inter-thread communication message. Storing the information related to a state of the first thread and the inter-thread communication message may include executing a function with a parameter, wherein the parameter may include a particular state of the first thread of the at least two threads or information related to the inter-thread communication.

Block 508 identifying an error location based on the information stored in the Thread Trace Log. Identifying the error location may include comparing, by the computing device, the Thread Trace Log with expected behavior, wherein the expected behavior comprises correct trace information; and identifying a difference between the Thread Trace Log and the expected behavior. Identifying the error location may include comparing, by a technician or engineer, the Thread Trace Log with the expected behavior. Alternatively or additionally, identifying the error location may include sending, by the computing device, the trace log to a human technician for comparison with expected behavior of the trace log. Identifying the error location may also involve receiving, by the computing device, an error input from the human technician. The error input may be a difference between the trace log and the expected behavior of the trace log.

While various examples and embodiments have been disclosed, other examples and embodiments will be apparent to those skilled in the art. The various disclosed examples and embodiments are for purposes of illustration and are not intended to be limiting, with the true scope and spirit being indicated by the following claims.

What is claimed is:

1. A computing device for locating an error in a multi-threaded printing system, comprising:
a processor;
a memory; and
program instructions, stored in the memory, that upon execution by the processor cause the computing device to perform operations comprising:
receiving, by the processor, a communication signal, wherein the communication signal initiates a first thread of at least two threads, wherein execution by the processor of the program instructions configures the first thread of the at least two threads to perform tasks related to a first element of the multi-threaded printing system;
sending, by the first thread via the processor, an inter-thread communication message to a second thread of the at least two threads, wherein execution by the processor of the program instructions configures the second thread of the at least two threads to perform tasks related to a second element of the multi-threaded printing system;
storing, in a trace log in the memory, information related to a state of the first thread and the inter-thread communication message; and
identifying an error location based on the information stored in the trace log.

2. The computing device of claim 1, wherein the communication signal comprises a semaphore or mutex.

3. The computing device of claim 1, wherein the first element of the multi-threaded printing system comprises performing one set of tasks related to a band of a printer image.

4. The computing device of claim 3, wherein the second element of the multi-threaded printing system comprises performing another set of tasks related to the band of the printer image.

5. The computing device of claim 1, wherein the inter-thread communication message comprises a command or data that can be retrieved and processed by the second thread of the at least two threads.

6. The computing device of claim 1, wherein sending the inter-thread communication message comprises sending the inter-thread communication message via a message queue.

7. The computing device of claim 1, wherein storing the information related to the inter-thread communication message comprises executing a function with a parameter, wherein the parameter comprises a particular state of the first thread of the at least two threads and information related to the inter-thread communication.

8. The computing device of claim 1, wherein identifying the error location comprises:
comparing the trace log with expected behavior, wherein the expected behavior comprises correct trace information; and
identifying a difference between the trace log and the expected behavior.

9. The computing device of claim 1, wherein identifying the error location comprises:
sending, by the computing device, the trace log to a human technician for comparison with expected behavior of the trace log; and
identifying a difference between the trace log and the expected behavior.

10. A method for locating an error in a multi-threaded printing system, comprising:
receiving, by a processor, a communication signal, wherein the communication signal initiates a first thread of at least two threads, wherein execution by the processor of program instructions configures the first thread of the at least two threads to perform tasks related to a first element of the multi-threaded printing system;
sending, by the first thread via the processor, an inter-thread communication message to a second thread of the at least two threads, wherein execution by the processor of the program instructions configures the second thread of the at least two threads to perform tasks related to a second element of the multi-threaded printing system;
storing, in a trace log in a memory, information related to a state of the first thread and the inter-thread communication message; and
identifying an error location based on the information stored in the trace log.

11. The method of claim 10, wherein the first element of the multi-threaded printing system comprises performing one set of tasks related to a band of a printer image.

12. The method of claim 11, wherein the second element of the multi-threaded printing system comprises performing another set of tasks related to the band of the printer image.

13. The method of claim 10, wherein the inter-thread communication message comprises a command or data that can be retrieved and processed by the second thread of the at least two threads.

14. The method of claim 10, wherein sending the inter-thread communication message comprises sending the inter-thread communication message via a message queue.

15. The method of claim 10, wherein identifying the error location comprises:
comparing, by the computing device, the trace log with expected behavior, wherein the expected behavior comprises correct trace information; and
identifying a difference between the trace log and the expected behavior.

16. A tangible, non-transitory computer-readable medium comprising program instructions encoded therein, wherein the program instructions, when executed by one or more processors, cause a printing device to perform a method comprising:
receiving, by the processor, a communication signal, wherein the communication signal initiates a first thread of at least two threads, wherein execution by the processor of the program instructions configures the first thread of the at least two threads to perform tasks related to a first element of the multi-threaded printing system;
sending, by the first thread via the processor, an inter-thread communication message to a second thread of the at least two threads, wherein execution by the processor of the program instructions configures the second thread of the at least two threads to perform tasks related to a second element of the multi-threaded printing system;
storing, in a trace log in a memory, information related to a state of the first thread and the inter-thread communication message; and
identifying an error location based on the information stored in the trace log.

17. The tangible, non-transitory computer-readable medium of claim 16, wherein the first element of the multi-threaded printing system comprises performing one set of tasks related to a band of a printer image.

18. The tangible, non-transitory computer-readable medium of claim 17, wherein the second element of the multi-threaded printing system comprises performing another set of tasks related to the band of the printer image.

19. The tangible, non-transitory computer-readable medium of claim 16, wherein the inter-thread communication message comprises a command or data that can be retrieved and processed by the second thread of the at least two threads.

20. The tangible, non-transitory computer-readable medium of claim 16, wherein sending the inter-thread communication message comprises sending the inter-thread communication message via a message queue.
